(19) United States
(12) Patent Application Publication
(10) Pub. No.: US 2002/0133952 A1
(43) Pub. Date: Sep. 26, 2002

(54) Knife blade guard

(76) Inventor: Edwin Kenny, Beaconsfield (CA)

Correspondence Address: Vincent L. Ramik, DILLER, RAMIK & WIGHT, Suite 101, 7345 McWhorter Place, Annandale, VA, 22003, US

(21) Appl. No.: 10/076,286

(22) Filed: Feb. 19, 2002

(30) Foreign Application Priority Data
Mar. 22, 2001 (CA) 2,341,787

(51) Int. Cl. B26B 29/02

(52) U.S. Cl. 30/151; 30/298.4

(57) ABSTRACT

The invention provides a blade guard comprising an elongated member of resilient material that has a longitudinal axis. The member has a portion of an outer surface extending parallel to the longitudinal axis and spaced from the axis. An elongated slit defined in the member includes slit walls defined by the resilient material. The slit extends in a plane extending from the portion of the outer surface inwardly of the member and parallel to the longitudinal axis. The member is adapted to engage the blade of a knife within the slit of the member and the resilience of the material of the slit walls is sufficient for the member to be held on the blade so as to cover a portion of a cutting edge of the blade.

### TECHNICAL FIELD

The present invention relates to knife blade guards and more particularly to a flexible knife blade guard capable of receiving and holding knife blades of varying shapes and sizes.

### BACKGROUND OF THE INVENTION

Blade guards that protect the edges of sharp instruments such as knives and chain saws are well known in the art. These guards may protect either the whole instrument, for example a sheath-like guard, or a sharp edge of the instrument. Such blade guards are typically shaped to conform to the contours of the particular instrument that they cover and are, therefore, not adaptable for use with other instruments that do not have the same shape.

There are numerous devices in the prior art suggesting knife guards for protecting the edge of a knife blade. One such device is shown in U.S. Pat. No. 2,517,649 to Frechtmann, issued Aug. 8, 1950. Frechtmann teaches a blade guard for protecting the edges of cutting devices. The blade guard comprises a readily flexible body that fits onto the edge of the blade, and a rigid non-resilient element which runs throughout the guard to maintain the body in a fixed position around the blade edge. An additional non-resilient end-clip is used to retain either side of the guard body against the blade in order to help secure the guard in position. The blade guard is cut to size, from standard lengths, for each blade length for which it is intended. It can be additionally shaped to fit the curvature of the blade to be protected, by cutting notches or darts into the top of the guard body.

None of the prior art devices are resiliently adaptable for use with a variety of blades of different lengths and sizes, without requiring a rigid element for securing the guard in place on the blade.

### SUMMARY OF THE INVENTION

It is, therefore, an object of the present invention to provide a blade guard adapted to be used with several different sharp instruments or knife blades.

It is another object of the present invention to provide a blade guard adapted to conform to the shape of any knife blade, and capable of remaining secured in place without the use of rigid non-resilient elements.

It is a further object of the present invention to provide a blade guard assembly capable of adapting to any length of blade, with the addition of supplemental segments to a minimum length base segment.

Therefore, in accordance with the present invention, there is provided a blade guard comprising: an elongated member of resilient material having a longitudinal axis, the member having a portion of an outer surface extending parallel to the longitudinal axis and spaced therefrom, an elongated slit defined in the member including slit walls defined by the resilient material, the slit extending in a plane extending from the portion of the outer surface inwardly of the member and parallel to the longitudinal axis, whereby the member is adapted to engage the blade of a knife within the slit of the member and the resilience of the material of the slit walls is sufficient for the member to be held on the blade so as to cover a portion of a cutting edge of the blade.

There is also provided, in accordance with the present invention, a blade guard comprising two elongated flexible members of resilient material having a common longitudinal axis, the members abutted end to end and having a portion of an outer surface extending parallel to the longitudinal axis and spaced therefrom, each having an elongated slit defined by the resilient material, the slit extending in a plane extending from the portion of the outer surface inwardly of the member and parallel to the longitudinal axis, whereby the slits of each member are coextensive therewith and adapted to engage a knife blade, the resilience of the material of the slit walls being sufficient for the members to be held on the blade so as to cover a cutting edge of the blade.

### BRIEF DESCRIPTION OF THE DRAWINGS

Further features and advantages of the present invention will become apparent from the following detailed description, taken in combination with the appended drawings, in which:

FIG. 1 is a perspective view of a preferred embodiment of a knife blade guard according to the present invention;

FIG. 2 is a perspective view of the knife blade guard of FIG. 1 with a knife blade edge located within the slit shown in dotted outline;

FIG. 3 is a fragmentary axial cross-section taken through the knife guard showing the blade in position within the guard; and

FIG. 4 is a perspective view of an alternate embodiment of the knife blade guard according to the present invention.

### DETAILED DESCRIPTION OF THE PREFERRED EMBODIMENT

The invention will be described with reference to its use with a knife 24 which has a blade 26 with a cutting edge 28.

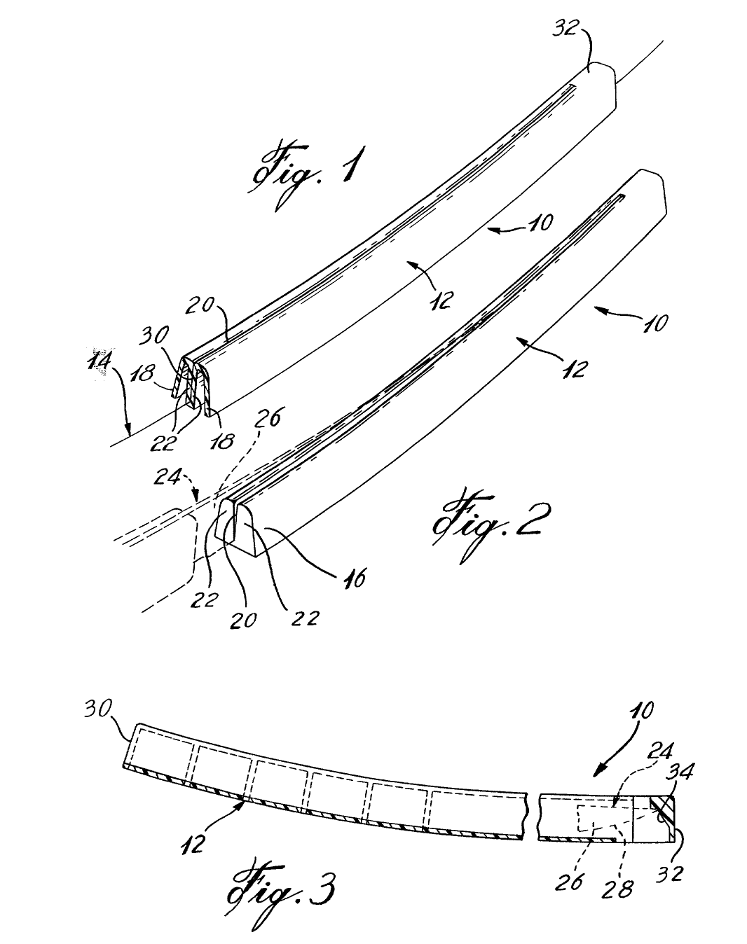

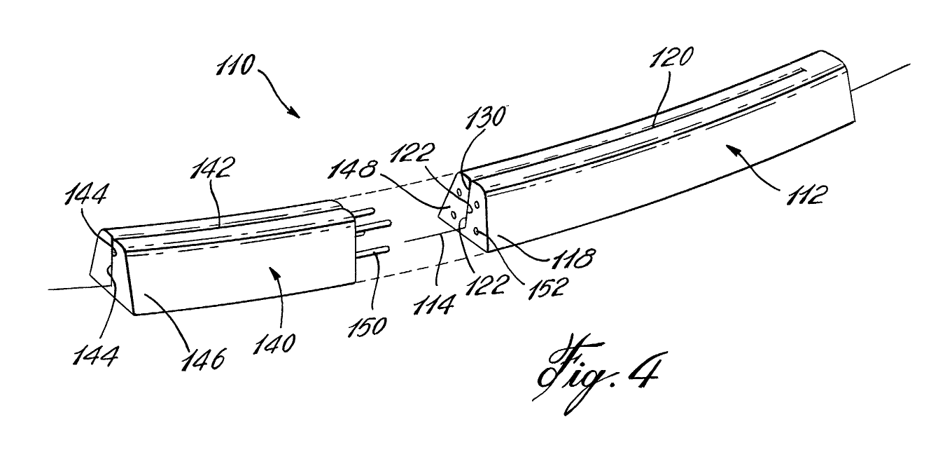

Referring to FIGS. 1, 2 and 3, the guard 10 has an elongated member 12 with a longitudinal axis 14 and a skirt portion 16 of an outer surface 18 extending parallel to and spaced from the longitudinal axis 14. A slit 20 is defined in the member 12 and includes slit walls 22 defined by the material of the member 12. The slit 20 extends in a plane extending parallel to the skirt portion 16 and along the longitudinal axis 14. The longitudinal axis 14 defines a curved path within the plane, such that the member 12 has an arched resting shape when viewed in a side elevation. The member 12 is adapted to engage the blade 26 of the knife 24 within the slit 20. The resilience of the material of the slit walls 22 is sufficient for the member 12 to be held on the blade 26, so as to cover the cutting edge 28 of the blade 26.

The member 12 is flexible and is of a length capable of receiving and holding the blade 26. The member 12 is made from resilient material that has a cork-like consistency. The material is preferably a molded plastic material with cork-like properties, for example, low density polyethylene. The member 12 is adapted to engage the blade 26 of the knife 24 by receiving the blade 26 within the slit 20 and the resilient material of the slit walls holding the blade 26 therein.

The slit 20 has an open end 30 and a closed end 32 located opposite the open end 30. When the knife 24 is held in the guard 10, it is positioned so that the tip of the knife blade 26 is located under a hook-shaped cavity 34 within the closed end 32. As a result, the blade 26 is held in a position in which the member 12 can be adapted to curve around the blade 26, thereby securing the cutting edge 28 within the slit walls 22, without requiring any non-resilient retention clips.

The arched resting shape of the resilient member 12 also aids the retention of the guard on the knife blade. When the tip of the blade is held by the hook-shaped cavity 34 and the member 12 is forced to conform to the shape of the blade, the resilience of the guard material causes longitudinal pressure on the blade edge, as the member 12 tries to return to its resting shape. The lateral frictional resistance between the blade 26 and the slit walls 22 prevents this, and the guard is, therefore, resiliently retained on the knife blade. While the guard 10 preferably has this arched resting shape to ensure blade retention, the guard would adequately function if it had a non-arched resting shape, such that the longitudinal axis 14 was horizontal in a side elevation.

In the embodiment shown, the guard 10 is made of a molded plastic material. In order to provide the proper flexibility and stability, the particular cross-sectioned shapes as shown in FIGS. 1 and 2 have been chosen. However, any other shape, including a full body, would be suitable.

In use, the tip of the blade 26 is positioned in the closed end 32 of the slit 20 to be received under the hook-shaped cavity 34. Once the end of the blade 26 is engaged under the hook-shaped cavity 34, the blade 26 can be fully received in the slit 20. The member 12 is flexible and bends to conform to the shape of the blade 26 in order that the slit walls 22 abut the cutting edge 28 and the guard 10 covers at least a portion of the blade 26. Once the cutting edge 28 is received within the slit 20, the resiliency of the material of the slit walls 22 retains the cutting edge 28 therein until the blade 26 is extracted from the guard 10.

When the knife 24 is required for use, the guard 10 can be removed by peeling the member 12 away from the blade 26, beginning at the open end 30. The open end 30 is first removed from the blade 26 and then the remainder of the member 12 is peeled away towards the closed end 32. When the end of the blade 26 is reached, it can be extracted from the hook-shaped cavity, allowing the knife 24 to be released from the guard 10.

FIG. 4 shows a knife guard 110 of an alternate embodiment, having two removably connected member sections, 112 and 140. The first, or base, member 112 has a longitudinal axis 114 and an outer surface 118. Much as in the first embodiment, a slit 120 is defined in the member 112 and includes slit walls 122 defined by the material of the member 112. The slit 120 extends in a plane extending substantially parallel to the outer surface 118, and along the axis 114.

The second, interchangeable, member 140 is generally shorter than the first member 112 and provides additional length for the knife blade guard 110. A slit 142 defined in the second member 140 has slit walls 142 defined by a material of the second member 140. The slit 142 similarly extends in a plane extending substantially parallel to the outer surface 146, and along the longitudinal axis 114 of the first member 112. The second member 140 abuts the first member 112 such that the slit 142 of the second member and the open end 130 of the slit 120 are aligned.

A pin and socket type plug connection retains the first and second members together. As shown in FIG. 4, the protruding pin portions 150 of the second member 140 axially engage with the corresponding socket portions 152 located in the end face 148 of the first member 112. It is to be understood, however, that the pins 150 could equally be located on the first member 112, and the corresponding sockets 152 could be located in the second member 140. The connection shown comprises four pins and four sockets, but fewer or more pins and sockets can be used as required.

The second member 140 can be of any length required to sufficiently cover the cutting edge 28 of a knife blade 26. Preferably, several members 140 of various lengths would be available, so that the knife guard 110 would be able to interchangeably accommodate knives of any length. The guard 110 is similarly comprised of a resilient material, such that the resilience of the material is such that the longitudinal curve and the friction of the slit walls on the knife blade are sufficient to hold the guard 110 on the blade 26.

While the embodiments discussed herein are directed to particular implementations of the invention, it will be apparent that variations of these embodiments are within the scope of the invention. For example, the material of the member can be any material that has resilient cork-like properties and is capable of receiving and retaining a knife blade and flexibly conforming to the shape of the blade. The member can be manufactured to be any desired length and width. The slit can be adapted to extend a greater distance inwardly of the member in order to accommodate larger knife blades.

The embodiments of the invention described above are intended to be exemplary only. The scope of the invention is, therefore, intended to be limited solely by the scope of the appended claims.

I claim:

1. A blade guard comprising an elongated member of resilient material having a longitudinal axis, the member having a portion of an outer surface extending parallel to the longitudinal axis and spaced therefrom, an elongated slit defined in the member including slit walls defined by the resilient material, the slit extending in a plane extending from the portion of the outer surface inwardly of the member and parallel to the longitudinal axis, whereby the member is adapted to engage a blade of a knife within the slit of the member and the resilience of the material of the slit walls is sufficient for the member to be held on the blade so as to cover a portion of a cutting edge of the blade.

2. A blade guard according to claim 1, wherein the slit has an open end and a closed end located opposite the open end.

3. A blade guard according to claim 2, wherein the slit has a cavity located at the closed end.

4. A blade guard according to claim 3, wherein the cavity is hook-shaped and adapted to engage a tip of the blade therein.

5. A blade guard according to claim 1, wherein the resilient material is cork-like.

6. A blade guard according to claim 1, wherein the resilient material is cork.

7. A blade guard according to claim 1, wherein the resilient material is low-density polyethylene.

8. A blade guard according to claim 1, wherein the elongated member is flexible.

9. A blade guard according to claim 1, wherein the longitudinal axis of the member defines a curved path within said plane extending from the portion of the outer surface inwardly of the member and parallel to the longitudinal axis, such that the member has an arched resting shape.

10. A blade guard according to claim 9, wherein tension resulting from conforming the arched resting shape of the member of resilient material to fit onto the blade, additionally helps to hold the member thereon.

11. A blade guard according to claim 1, wherein the member is of a variable length.

12. A blade guard according to claim 11, wherein the member is made up of two members, a first base member and a second interchangeable member.

13. A blade guard according to claim 12, wherein the first member is of a length adapted to receive a blade of a minimum length, and the second member provides additional guard length as required.

14. A blade guard according to claim 13, wherein each member has a joint face, such that the joint face of the second member abuts the joint face of the first member such that the slits of said first and second members are aligned and adapted to receive a blade having a cutting edge, the length of said second member chosen such that the total length of the first and second members covers the cutting edge of the blade.

15. A blade guard according to claim 14, wherein a pin and socket attachment connects the first and second members together.

16. A blade guard comprising two elongated flexible members of resilient material having a common longitudinal axis, the members abutted end to end and having a portion of an outer surface extending parallel to the longitudinal axis and spaced therefrom, each having an elongated slit defined by the resilient material, the slit extending in a plane extending from the portion of the outer surface inwardly of the member and parallel to the longitudinal axis, whereby the slits of each member are coextensive therewith and adapted to engage a knife blade, the resilience of the material of the slit walls being sufficient for the members to be held on the blade so as to cover a cutting edge of the blade.

17. A blade guard according to claim 16, wherein the two members are retained together by a pin and socket plug connection.

18. A blade guard according to claim 16, wherein the longitudinal axis of the members defines a curved path within said plane extending from the portion of the outer surface inwardly of the member and parallel to the longitudinal axis, such that the member has a arched resting shape.
